(19) United States
(12) Patent Application Publication
(10) Pub. No.: US 2019/0042720 A1
(43) Pub. Date: Feb. 7, 2019

(54) APPARATUS FOR AUTHENTICATING PACKAGE DELIVERY

(71) Applicant: Cheryl Delts, Rockville, MD (US)

(72) Inventor: Cheryl Delts, Rockville, MD (US)

(21) Appl. No.: 16/151,683

(22) Filed: Oct. 4, 2018

(51) Int. Cl. G06F 21/32; G06Q 10/08; G06F 3/0488; H04W 4/029; G06K 9/00

(52) U.S. Cl. CPC G06F 21/32; G06Q 10/0833; G06K 9/00154; H04W 4/029; G06F 3/04883

(57) ABSTRACT

The various embodiments herein provide an improved apparatus for authenticating a consignee of a consignment. The apparatus is configured to be used by any package handling personnel to collect biometric fingerprint information and signatures in digital format for authenticating a delivery or transaction. The apparatus further includes a location-based module such as GPS for enabling location-based authentication and verification of authenticity of a transaction. The apparatus is further configured to connect to a computing device to send and/or receive information.

### BACKGROUND

### Technical Field

The embodiments herein generally relate to an apparatus for package signing. The embodiments herein particularly relate to an improved apparatus for package signing. The embodiments herein more particularly relate to a system for remotely authenticating a consignee.

### Description of the Related Art

With the increased use of online shopping and e-commerce applications, the need for systems for enabling secured and authenticated financial transactions is also on the rise.

Currently available options enable a customer to pay through online transactions or through cash-on-delivery modes. However, there are no easily usable authentication systems that confirm the proper delivery of a purchase item to the rightful purchaser.

Hence, there is a need for a system to enable authentication of a consignee prior to delivering a consignment. There is also a need for a system to enable remote authentication and verifying the same through location based services.

The abovementioned shortcomings, disadvantages and problems are addressed herein and which will be understood by reading and studying the following specification.

### OBJECT OF THE EMBODIMENTS HEREIN

The primary object of the embodiments herein is to provide an improved apparatus for authenticating package delivery.

Another object of the embodiments herein is to provide an apparatus for remotely authenticating a consignee.

Yet another object of the embodiments herein is to provide an apparatus for using location-based services to verify the authenticity of a consignee.

Yet another object of the embodiments herein is to provide an apparatus for enabling biometric authentication.

Yet another object of the embodiments herein is to provide an apparatus for enabling haptic authentication.

These and other objects and advantages of the embodiments herein will become readily apparent from the following summary and the detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide an improved apparatus for authenticating package delivery. The apparatus is configured to be used by any package handling personnel to collect biometric input information and electronic signatures for authenticating a delivery or transaction. The apparatus further includes a location tracking module such as GPS for enabling location-based authentication and verification of authenticity of a transaction. The apparatus is also configured to connect to a computing device to send and receive information.

According to an embodiment herein, an apparatus for remotely authenticating a consignee is provided. The apparatus comprises a biometric sensing module, a digital haptic input module, a barcode scanning module, a display module, a location tracking module, a computing module and a communication module.

According to an embodiment herein, the biometric sensing module is configured to receive a biometric input from a consignee. The biometric inputs received from the consignee comprises one of a fingerprint, palm print, finger pores, hand geometry, iris, retina, tragus, voice and face recognition.

According to an embodiment herein, the digital haptic input module is configured to receive a haptic input from a consignee. The digital haptic input comprises an electronic signature of a consignee.

According to an embodiment herein, the display module is a digital display module. In some embodiments, the display module is integrated with the haptic interface module in form of a touch-sensitive display screen.

According to an embodiment herein, the location tracking module is configured to identify the location at which an input is received from the consignee on the biometric sensing module or the digital haptic input module. Accordingly, the location tracking unit may comprise a global positioning system (GPS) unit that can access global positioning system (GPS) signals and/or signals from other global navigation satellite systems (GNSSs). In one example, the location information can include an estimate of a current location of the apparatus.

According to an embodiment herein, the computing module is configured to connect to other modules and digitally store a plurality of digital information.

According to an embodiment herein, the communication module is configured to connect the apparatus to a plurality of computing devices through a plurality of wired or wireless protocols.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of an apparatus for remotely authenticating a consignee, according to an embodiment herein.

FIG. 2 illustrates a front view of an exemplary apparatus for remotely authenticating a consignee, according to an embodiment herein.

FIG. 3 illustrates a front view of yet another exemplary apparatus for remotely authenticating a consignee, according to an embodiment herein.

FIG. 4 illustrates a front view of yet another exemplary apparatus for remotely authenticating a consignee, according to an embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide an improved apparatus for authenticating package delivery. The apparatus is configured to be used by any package handling personnel to collect biometric input information and signatures in digital format for authenticating a delivery or transaction. The apparatus further includes a location-based module such as GPS for enabling location-based authentication and verification of authenticity of a transaction. The apparatus is also configured to connect to a computing device to send and receive information.

According to an embodiment herein, an apparatus for remotely authenticating a consignee of a delivery package is provided. The apparatus comprises a biometric sensing module, a digital haptic input module, a barcode scanning module, a display module, a GPS module, a computing module and a communication module.

According to an embodiment herein, the biometric sensing module is configured to receive a biometric information from a consignee. The biometric information received from the consignee includes fingerprint, palm print, finger pores, hand geometry, iris, retina, tragus, voice and face recognition.

According to an embodiment herein, the digital haptic input module is configured to receive a haptic input from a consignee. The digital haptic input is an electronic signature of a consignee.

According to an embodiment herein, the display module is a digital display module. In some embodiments, the display module is integrated with the haptic interface module in form of a touch-sensitive display screen.

According to an embodiment herein, the location tracking module is a GPS module that is configured to identify the location at which an input is received from the consignee on the biometric sensing module or the digital haptic input module.

According to an embodiment herein, the computing module is configured to connect to other modules and digitally store a plurality of digital information.

According to an embodiment herein, the communication module is configured to connect the apparatus to a plurality of computing devices using one of a plurality of wired or wireless protocols.

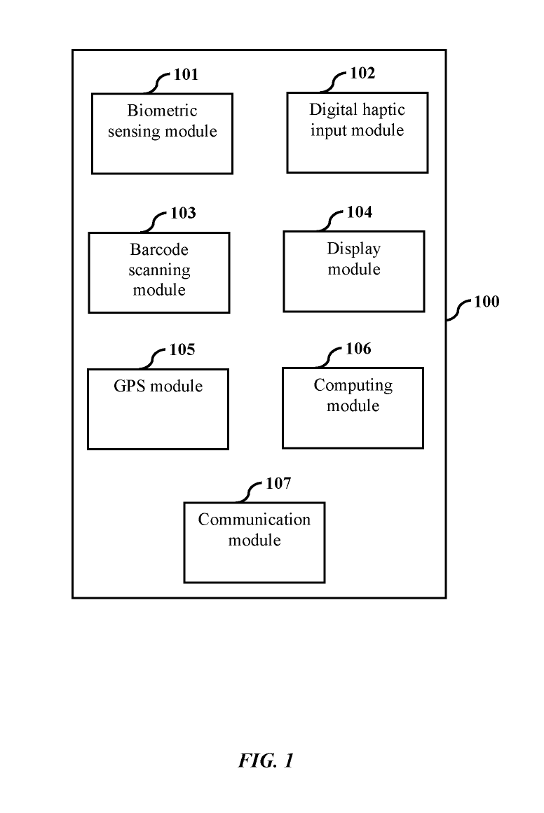

FIG. 1 illustrates a functional block diagram of an apparatus 100 for authenticating a consignee. The apparatus 100 comprises a biometric sensing module 101, a digital haptic inputs module 102, a barcode scanning module 103, a display module 104, a GPS module 105, a computing module 106 and a communication module 107.

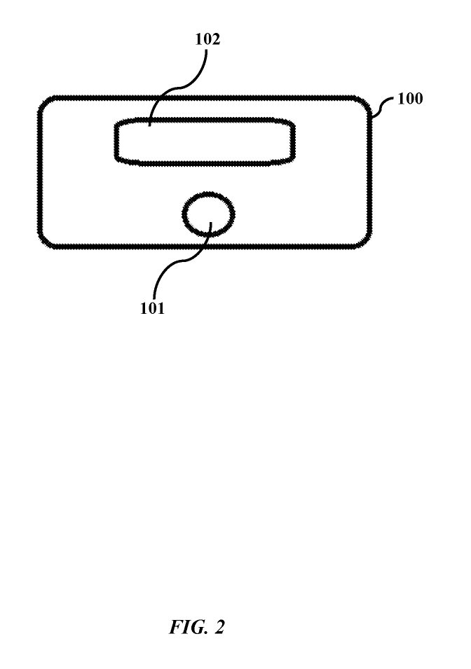

FIG. 2 illustrates a front view of an exemplary apparatus for authenticating a consignee.

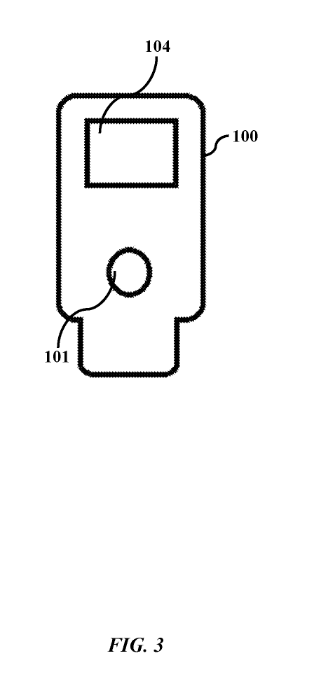

FIG. 3 illustrates a front view of yet another exemplary apparatus for authenticating a consignee.

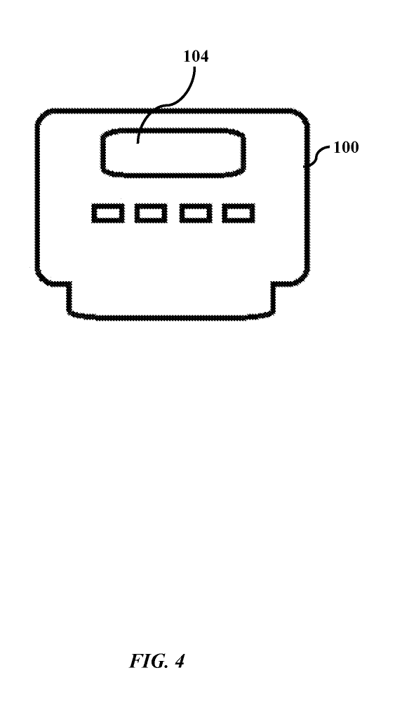

FIG. 4 illustrates a front view of yet another exemplary apparatus for authenticating a consignee.

The advantages of the embodiments disclosed herein comprise an improvement over existing package signing machine. The embodiments herein comprise a biometric fingerprint scanning module for enabling authentication of the consignee. The embodiments also comprise a digital haptic interface for receiving signature information from multiple consignees. The embodiments are also enabled with location-based sensors such as GPS for providing location-based authentication and verification to transactions.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the appended claims.

It is also to be understood that the following claims are intended to cover all of the generic and specific features of the embodiments described herein and all the statements of the scope of the embodiments which as a matter of language might be said to fall there between.

What is claimed is:

1. An apparatus for authenticating a consignee, the apparatus comprising:
an input module configured for obtaining input information of a consignee of a consignment;
a digital haptic input module configured for obtaining electronic signature of the consignee;
a barcode scanning module configured for scanning machine readable code imprinted on the consignment;
a computing module coupled to the input module, the computing module configured for authenticating the consignee based on the input information;
a display module configured for displaying information regarding at least one of the consignee and the consignment;
a location tracking module configured for determining location of the apparatus; and
a communication module configured for communicating with a computing device.
wherein the input module is a biometric sensing module configured for obtaining biometric information of the consignee.

2. The apparatus according to claim 1, wherein the biometric sensing module is configured to receive a biometric information from the consignee, and wherein the biometric information received from the consignee comprises one of a fingerprint, palm print, finger pores, hand geometry, iris, retina, tragus, voice and face recognition.

3. The apparatus according to claim 1, wherein the digital haptic input module is configured to receive a haptic input from the consignee, and wherein the digital haptic input is a signature of a consignee.

4. The apparatus according to claim 1, wherein the computing module is configured for matching the input information with a information stored, generating a matching score based on the comparison and generating an alert signal based on the matching score.

5. The apparatus according to claim 1, wherein the display module is a digital display module, and wherein the display module is integrated with the haptic interface module in form of a touch-sensitive display screen.

6. The apparatus according to claim 1, wherein the location tracking module is a GPS module configured to identify the location at which an input is received from the consignee on the biometric sensing module or the digital haptic input module.

7. The apparatus according to claim 1, wherein the computing module is configured to connect to other modules and digitally store a plurality of digital information.

8. The apparatus according to claim 1, wherein the communication module is configured to connect the apparatus to a plurality of computing devices through a plurality of wired or wireless protocols.
